(19) United States
(12) Patent Application Publication
(10) Pub. No.: US 2004/0091581 A1
(43) Pub. Date: May 13, 2004

(54) Starch/collagen casings for co-extruded food products

(76) Inventors: Ghislaine Joly, Bridgewater, NJ (US); James J. Kasica, Whitehouse Station, NJ (US); Robert O'Mara, Stockton, NJ (US); Roxanna Shariff, Somerville, NJ (US)

Correspondence Address: NATIONAL STARCH AND CHEMICAL COMPANY, P.O. BOX 6500, BRIDGEWATER, NJ, 08807-3300, US

(21) Appl. No.: 10/291,888

(22) Filed: Nov. 8, 2002

(51) Int. Cl. A23L 1/31

(52) U.S. Cl. 426/92

(57) ABSTRACT

Composites or combinations of selected starches and collagen provide very useful casing materials for co-extruded food products such as sausage. The casing material includes collagen and a) a gel forming, non-degraded, amylose containing dispersed starch, or b) a gel forming, non-degraded, chemically crosslinked or physically inhibited amylopectin dispersed starch, wherein the starch in a) or b) is characterized by a G′ of 600 Pa or greater at a frequency of 0.1 rad/sec at 25° C. provided the starch is prepared at a solid concentration of 10 wt. %, the amount of starch to collagen being from about 0.05:1 to 10:1 parts by weight on a dry basis.

### BACKGROUND OF THE INVENTION

1. Technical Field

This invention relates to the use of composites or combinations of selected starches and collagen as casing material for co-extruded food products such as sausage, hot dogs and other products containing emulsion meats.

2. Background Information

Casings are used as a uniform layer or film to hold, enclose or envelope food and meat products. The casings can either be co-extruded along with the food or preformed. Depending on the actual form of the casing, its method of production, the contained food and the processing thereof, the chosen casing material must satisfy a number of required properties. This includes organoleptic properties such as taste and strength, flexibility and other physical and rheological properties as well as compatibility with the food.

Traditionally, sausage and other meat product casings have been made of animal intestines (natural casings). Due to the increased volume of sausage production and the limited availability of animal intestines, alternatives to such natural casings have been developed. These alternatives include fibrous cellulose, plastic polyethylene and collagen. Some alternatives use non-edible material and require the casing skin or film to be peeled off prior to consumption and often involve other processing steps.

Co-extrusion of food or meat with a uniform layer of edible casing material such as collagen has been found to be an especially useful process. Early use of this process is disclosed in G.B. Patent No. 1,232,801 published on May 19, 1971, where a uniform layer of collagen gel is co-extruded around an edible product and the collagen is coagulated by passing through a brine bath to set the collagen coating and to remove some of the water and subsequently crimping/cutting the individual links and air drying. A recent disclosure is found in U.S. Pat. No. 6,235,328 issued on May 22, 2001 to T. F. Morgan et al., wherein an improved technique for making a collagen casing of sufficient strength to allow mechanical separation into sausage links is shown. In this patent, an edible meat product is co-extruded with collagen gel and the collagen is contacted with a chemical coagulating agent (aqueous alkali or salt solution) to remove water and alternatively or additionally is chemically modified by cross-linking.

Another recent disclosure is found in WO 00/02463 published on Jan. 20, 2000 and involves a technique to avoid casing splits during cooking. In this method an edible material such as collagen is co-extruded around an inner food layer and then coagulated to form a casing material. This formed product is then treated with a flowable anti-dehydrating agent such as an edible oil, edible fat or polyhydric alcohol either before or after linking into individual products. The resulting products exhibit limited or significantly reduced casing splits during subsequent cooking.

Collagen, a protein, is edible and has excellent properties making it well suited for forming and use as a casing for food products as illustrated in the above noted references. However, because of its limited availability, high cost and the recent outbreaks of BSE (bovine spongiform encephalopathy) and foot and mouth disease, alternatives or replacement of some or all of the collagen are being sought in the industry. In view of the many requirements that casing materials must satisfy and because of various useful and unique properties provided by collagen, this has not been easily accomplished.

### SUMMARY OF THE INVENTION

It has now been surprisingly and unexpectedly found that compositions comprising composites or combinations of selected starches and collagen provide very useful casing materials for co-extruded food products such as sausage. The amount of starch that can be used in the starch/collagen composite will vary depending on the particular starch used.

One embodiment of this invention involves starch/collagen composites using starch in varying and large amounts. More particularly, this embodiment is directed to a casing material for co-extruded food products comprising collagen and a) a gel forming, non-degraded, amylose containing dispersed starch, or b) a gel forming, non-degraded, chemically crosslinked or physically inhibited amylopectin dispersed starch, wherein the starch in a) or b) is characterized by a G′ of 600 Pa or greater at a frequency of 0.1 rad/sec at 25° C. provided the starch is prepared at a solid concentration of 10 wt. %, the amount of starch to collagen being from about 0.05:1 to 10:1 parts by weight on a dry basis.

In another embodiment, the combination of collagen and a varying small amount of starch is used to provide a casing material for food products, the amount of starch to collagen being from about 0.05:1 to 0.8:1 parts by weight on a dry basis.

### DETAILED DESCRIPTION OF THE INVENTION

Collagen, a protein material derived from animals, has been used as a casing material for sausage and other meat products. A process for producing co-extruded meat products with collagen is disclosed in U.S. Pat. No. 6,235,328 issued May 22, 2001 to Trevor F. Morgan et al. In this process, collagen gel is co-extruded with the meat product using a chemical coagulating agent such as a salt solution (e.g., sodium chloride or sodium carbonate) to set the film and to remove water and alternatively or additionally modified with a crosslinking agent for the collagen (e.g., glutaraldehyde or liquid smoke) to harden the casing.

Generally, starch used in combination with collagen has not been found suitable to form satisfactory casings for food products. This is probably because of the unique properties provided by collagen, a protein, and the very different characteristics of starch. In order for starch to act as a replacement for collagen in significant amounts in forming a casing, besides providing good film forming and strength properties, it must also be compatible with both collagen and the food material. Optimally, to avoid blistering, a continuous film must be formed in the wet film during processing and on the final product. The starch/collagen film must also be able to dehydrate in the brine bath or alkaline solution of the process and form a continuous film.

The term “food” or “food material” as used throughout the specification and claims refers to any food, meat and/or meat analogs (e.g., soy products) including beef, pork, veal, poultry (chicken, turkey), emulsion meats, muscle or offal meats, fish, and foodstuffs such as products containing vegetable or cheese or both. The encased food or final food product, i.e., the food plus casing material, can include sausage, hot dogs, frankfurters, luncheon meat and bratwurst, etc.

In accordance with this invention, it has been found that the use of selected starch materials are capable of providing the necessary properties to act as suitable casing materials when combined with collagen in varying and large amounts. The selected starches are either a) a gel forming, non-degraded, amylose containing dispersed starch, or b) a gel forming, non-degraded, crosslinked or physically inhibited amylopectin dispersed starch. Either starch a) or b) are further characterized by a G′ of 600 Pa or greater at a frequency of 0.1 rad/sec at 25° C. provided the starch is prepared at a solid concentration of 10 weight % (i.e., the test starch being evaluated for G′). Blends of starch, i.e., blends of different a) and/or different b) type starches can be used as long as the necessary characteristics including the desired G′ characteristic are satisfied and the starch blend is dispersible.

A dispersed starch is a starch that has been thermally cooked or chemically dispersed such that the starch granules lose their birefringency (crystallinity) to optimally form a colloidal dispersion where the starch molecules are randomized in the media (water) or in the case of a chemically crosslinked or physically inhibited starch, the granules are fully hydrated. A physically processed starch with the intent to cook (e.g., cook, spray-dried, drum-dried, extruded or the like) results in a pregelatinized form, and once hydrated, can also result in a colloidal dispersion. This process is called gelatinization. Gelatinization can take place or occur in different degrees and optimally there is complete gelatinization or complete dispersion. Once an amylose containing starch is dispersed, the amylose upon cooling or dehydration can retrograde and contribute to the gelling properties. A measure of gelling properties is G′.

G′ is the elastic modulus of a gel measured in Pascals (Pa). To measure G′ values, a selected starch or starch blend having a 10 wt. % anhydrous starch solid concentration is completely dispersed in water. The dispersed starch is then placed in moulds which are conditioned at 25° C. for 48 hours and then placed on a rheometer plate at a temperature of 25° C. A dynamic frequency sleep is performed on the test sample with the G′ in Pascals being obtained. Further discussion of this and related techniques are given below.

The selected starches for the embodiment of this invention where varying and large amounts of starch can be used in collagen composites either are gel forming, non-degraded, amylose containing or gel forming, non-degraded. crosslinked or physically inhibited amylopectin dispersed starches. By “amylose containing” is meant starches having at least 5% by weight amylose content. This includes starches from any amylose containing starch source such as cereals, tubers, roots, pith, legumes, fruit starches and hybrid starches. Suitable starches include those derived from plant sources such as corn, potato, wheat, sago, tapioca, sorghum, rice, pea and high amylose starch, i.e., starch having at least 40% by weight of amylose content, e.g., high amylose corn.

The amylose starches useful in this invention may also be modified. By modified it is meant that the starch can be chemically derivatized or modified by processes known in the art, e.g., esterification and etherification. Typical modified starches include esters such as the acetate and the half esters, such as succinate and octenyl succinate, prepared by reaction with acetic anhydride, succinic anhydride and octenyl succinic anhydride, respectively; ethers prepared by reaction with alkylene oxide such as ethylene oxide and propylene oxide; and phosphate ester derivatives prepared by reaction with sodium or potassium orthophosphate or sodium or potassium tripolyphosphate. Crosslinked amylose starches prepared with crosslinking agents such as phosphorous oxychloride, epichlorohydrin, sodium trimetaphosphate and adipic-acetic anhydride may also be used. It is noted that the degree of chemical modification and/or crosslinking or inhibition must be controlled so that the starch retains the necessary characteristics including the specified G′ and is dispersible. Modification that degrades the starch, e.g., acid, enzyme, oxidation and physical shear are not preferable but can be acceptable as long as desired G′ values are obtained.

The amylopectin starches useful in this invention where varying and large amounts of starch are used are those having high amylopectin content of about 90% or more by weight and more particularly about 95% or more. Starches of this type include the waxy starches and especially waxy maize, waxy rice, waxy sorghum, waxy potato and waxy tapioca.

The amylopectin starches as described above must be crosslinked or physically inhibited. Crosslinking can be accomplished using crosslinking agents such as phosphorous oxychloride, epichlorohydrin, sodium trimetaphosphate and adipic-acetic anhydride. It is noted that the degree of crosslinking and physical inhibition must be controlled so that the starch retains the necessary characteristics including the specified G′ and is dispersible. The crosslinking can vary depending on the components used and other conditions but typically will vary between about 0.001 to 5% by weight crosslinking agent based on the weight of starch and more particularly between about 0.005 to 1%. It is preferred to use food approved treatment levels according to Food Chemical Codex. If the starch is over-crosslinked, it may be stabilized to provide improved dispersion characteristics by adding a mono-substituent such as esters, e.g., acetate and half esters including succinate and octenyl succinate, ethers prepared by the reaction with alkylene oxide such as ethylene and propylene oxide and phosphate ester derivatives prepared by reaction with sodium or potassium orthophosphate or sodium or potassium tripolyphosphate. Monosubstitution can help to disperse or hydrate difficult to cook starch such as high amylose or heavily crosslinked or inhibited types. However, too much monosubstitution may stabilize the dispersed or hydrated starches resulting in low G′ values.

Physically modified starches, such as thermally-inhibited starches described in U.S. Pat. No. 5,725,676 issued on Mar. 10, 1998 to Chung-Wai Chiu, and thermally-inhibited pregelatinized granular starches described in U.S. Pat. No. 5,718,770 issued on Feb. 17, 1998 to M. Shah et al., are also suitable for use herein. These thermally inhibited starches function in a similar manner as the chemically crosslinked types mentioned above, and may be used instead of crosslinked starch in either the selected amylose or amylopectin starches described above.

Procedures for modifying starches are described in “Starch and Its Modification” by M. W. Rutenberg, pp. 22-26 to 22-47, Handbook of Water Soluble Gums and Resins, R. L. Davidson, Ed., McGraw Hill, Inc., New York, N.Y. (1980). Further description of starch derivatives can be found in “Starch: Chemistry and Technology”, 2^{nd} Ed., R. L. Whistler et al., Ed., Chpt. X (1984).

The selected starches used in the high starch-containing embodiment of this invention must be dispersed, i.e., cooked or pre-gelatinized. The starch may be cooked using any of the known techniques including atmospheric cooking, heat exchanger cooking and jet cooking or steam injection cooking. Particularly useful techniques are spray-drying using a steam injection dual or single-atomization process as described in U.S. Pat. Nos. 4,280,851, 4,600,472 and 5,149,799, the disclosures of which are incorporated herein by reference.

These cook spray-drying processes have in common the ability to pregelatinize high viscosity, non-degraded starch, and are particularly useful in this invention. Nozzles suitable for use in the preparation of these starches are also described in U.S. Pat. No. 4,610,760, incorporated herein by reference.

The steam injection/dual atomization (SIDA) process as referred to above may be more particularly described as pregelatinization of the starch by a) mixing the starch in an aqueous solvent, b) atomizing the mixture with an enclosed chamber, and c) interjecting a heating medium into the atomized mixture in the enclosed chamber to cook the starch, the size and shape of the chamber being effective to maintain the temperature and moisture control of the starch for a period of time sufficient to cook said starch.

A steam injection/single atomization process for cooking and spray-drying starch is disclosed in the U.S. Pat. No. 5,149,799 referred to above and comprises a) slurrying the starch in an aqueous medium, b) feeding a stream of the starch slurry at a pressure from about 50 to about 250 psig into an atomizing chamber within a spray nozzle, c) injecting a heating medium into the atomizing chamber at a pressure from about 50 to about 250 psig, d) simultaneously cooking and atomizing the starch slurry as the heating medium forces the starch through a vent at the bottom of the chamber, and e) drying the atomized starch.

Another process for cooking and pregelatinization of starch is disclosed in U.S. Pat. No. 5,318,635. This patent involves a continuous coupled jet-cooking/spray drying process for starch and is incorporated herein by reference.

Other ways to pregelatinize starch include extrusion, drum drying and other physical methods known in the art. Conventional procedures for pregelatinizing starch are well known and described in Starch: Chemistry and Technology, Vol. III, R. L. Whistler et al. Ed., Chpt. XXII, “Production and Use of Pregelatinized Starch” (1967).

In order for starch to be suitable as a partial replacement for collagen in casing materials it must possess certain characteristics that will allow the combined casing material to perform well in both the processing and use of the finished food product. This means that the starch must be compatible with collagen, have suitable viscosity to allow processing with collagen, e.g. co-extrusion, possess in-process wet film strength for processing and handling and also possess final product film strength upon aging and reconstitution (in boiling water, grilling, microwaving, frying). Besides the necessary physical properties, the starch must also possess and maintain desired organoleptic characteristics in the final product such as taste and color or clarity and the textural attributes (e.g., bite) of the standard product.

It has been found that selected starches provide the characteristics and properties that make them useful when combined in varying and large amounts with collagen as casing materials. The selected starches are gel forming, non-degraded, amylose containing dispersed starches or gel forming, non-degraded, chemically crosslinked or physically inhibited amylopectin starches wherein the starch is further characterized by a G′ of 600 Pa or greater at a frequency of 0.1 rad/sec at 25° C. provided the starch is prepared at a solid concentration of 10 wt. %. Starch having the defined characteristics are compatible with collagen, have suitable viscosity for processing with collagen and the food material being encased, and have desired wet and dry film strengths for processing and subsequent applications.

Useful selected starches will have a G′ as defined herein of 600 Pa or greater, particularly from about 600 Pa to 500,000 Pa, and preferably from about 800 Pa to 100,000 Pa. The preferred selected starches are amylose containing and have at least 5% by weight amylose content, more particularly from about 10 to 98 wt. % amylose and preferably from about 15 to 95 wt. % amylose content.

The amount of selected starch and collagen used in the casing material in accordance with the embodiment of this invention using varying and high amounts of non-degraded amylose containing starch or chemically crosslinked or physically inhibited amylopectin starch, will be sufficient to provide suitable properties and characteristics as described herein. The amount or proportion of starch to collagen will vary from about 0.05:1 to 10:1 more particularly from about 0.05:1 to 4:1 and preferably from about 0.1:1 to 3:1, parts by weight, based on the dry weight of starch and collagen. It is noted that collagen is available in various aqueous concentrations but usually is found in amounts of about 3 to 12% by weight of collagen solids. Collagen is typically referred to in the industry as collagen dough or collagen gel.

In another embodiment of this invention, various starches can be used but in smaller amounts in combination with collagen to form casings for food products. Starches used in this embodiment may be any of several starches, native or converted. Such starches include those derived from any plant source including corn, potato, wheat, sago, tapioca, sorghum, rice, pea and the waxy variety of these starches, e.g., waxy maize, and the high amylose varieties of these starches, i.e., starch having at least 40% by weight of amylose content. Also included are the conversion products derived from any of the former bases. These include, for example, dextrin prepared by hydrolytic action of acid and/or heat; oxidized starches prepared by treatment with oxidants such as sodium hypochlorite; fluidity or thin boiling starches prepared by enzyme conversion or mild acid hydrolysis; and chemically derivatized or modified and chemically crosslinked or physically inhibited starches as described earlier. The amount or proportion of starch to collagen used in this embodiment will vary from about 0.05:1 to 0.8:1 parts by weight and more particularly from about 0.05:1 to 0.7:1 parts by weight, based on the dry weight of starch and collagen.

The casing material of this invention may be formed using different processes known in the art, however, a co-extrusion process wherein the casing material is co-extruded with the food has been found especially useful. In this process, the food or food material is co-extruded along with collagen and starch to form an encased food product having an outer layer or film of collagen and starch casing. It is necessary that the co-extruded product is coagulated and dehydrated to set the film and to remove water by passing through a brine solution or bath. The brine solution or bath may comprise an alkaline salt solution such as an alkali or alkaline earth metal salt including sodium, potassium, calcium and ammonium salts. These salts include food grade salts such as chloride, carbonate, bicarbonate, phosphate, sulfate and hydroxide. Illustrative salts include sodium chloride, sodium carbonate, sodium bicarbonate, dipotassium phosphate, ammonium sulfate and ammonium hydroxide. The food grade salts, particularly dipotassium phosphate, are preferred. One such process is disclosed in U.S. Pat. No. 6,235,328 issued May 22, 2001 to Trevor F. Morgan et al. This patent discloses the co-extrusion of collagen gel with meat products using a chemical coagulating agent to harden the casing and provide sufficient mechanical strength. The disclosure of the '328 patent is incorporated herein by reference. Suitable co-extruders for use in connection with this process are represented by the Kontura System commercially available from Townsend Engineering Company (Des Moines, Iowa). Further details regarding co-extruders can be found in U.S. Pat. Nos. 5,843,504 and 6,054,155, the disclosures of which are incorporated herein by reference.

The starch and collagen can be added as separate ingredients and mixed in a mixer box during co-extrusion. Alternatively, the starch and collagen can be combined to form a composite mix which is added as a combined mix to the extruder. In the latter case, the composite mix can be prepared by any process capable of mixing highly viscous materials without incorporating or entrapping air. Starch is first dispersed or hydrated and is minimally cooled to a temperature not to affect the protein of collagen dough (i.e., not denature the protein). The collagen gel or dough is combined with the starch and is mechanically sheared to intimately mix to form a homogenous composite without air entrapment. A vacuum may be used to degas the composite during or post shear. Preferably, a vacuum bowl chopper is used.

Other additives such as coloring agents, opacifying agents, flavor components, preservatives or pH modifying materials (e.g., lactic or citric acid) may be added prior, during or post shear as long as the composite is degassed.

The film thickness of the composite or casing, i.e., starch and collagen, can vary and is dependent upon the composite solids and is in proportion to the diameter of the food product. The film usually will vary from about 0.05 to 1.0 mm, more particularly from about 0.05 to 0.6 mm and most particularly from about 0.1 to 0.3 mm. The weight of the casing film can vary from about 1 to 15% by weight (as solids) based on the total weight of the food product (food plus casing), more particularly from about 2 to 10%, and most particularly form about 3 to 6%.

The following test methods and procedures were used to determine G′ of the starches and for other evaluations of the starches.

### Starch Rheology Test Method

Rheology tests on the starch dispersions were carried out on a Rheometrics Fluid Spectrometer II (obtained from Rheometrics Scientific, Piscataway, N.J.). Measurements were made using parallel plate geometry in all cases.

Samples of the granular starches were prepared as a slurry at 10% solids and then bath cooked for twenty minutes at 95° C. For samples that were physically processed (extruded starch and steam injection dual atomization or SIDA processed starch), a Waring blender was used to disperse the samples. The starch was added to room temperature water in the vortex of the blender cup and was mixed for one minute.

After complete dispersion, the sample was then poured into moulds. The moulds were made by placing a 2 mm thick piece of silicone rubber of size 75 mm×75 mm over an aluminum plate of the same size. The silicone rubber had an inner circular cut with a diameter of 50 mm. The rubber was sealed to the metal plate by using a few drops of low viscosity silicone oil. This was to help prevent the sample from leaking out. After pouring the sample into the moulds it was covered with a piece of Mylar film so as to prevent evaporation of the sample. The moulds were stored for 48 hours at 25° C.

After 48 hours, the samples were loaded on the rheometer. The silicone rubber was removed carefully from the aluminum plate leaving the sample in the shape of a circle with a diameter of 50 mm. Measurements were then made on the rheometer at 25° C. The rheological test done on the starch dispersions was designed to measure the degree of structure in the sample. A dynamic frequency sweep was begun immediately after the sample was loaded on the rheometer at 25° C. The dynamic frequency sweep was run at a frequency from 0.1 rad/sec to 100 rad/sec with a strain in the linear viscoelastic window of the sample. The linear viscoelasitc strain is defined as a strain which is small enough that it does not disrupt the structure of the material being measured. The resulting profile of G′ in Pascals (Pa) is taken at a frequency of 0.1 rad/sec to 100 rad/sec and the value at 0.1 rad/sec is recorded.

### Smokehouse Processing

Smokehouse processing is used to cook the co-extruded food product. Liquid smoke is a collagen crosslinker applied by dipping the meat product (hot dog) during the cooking process. Cooking is accomplished by steam or gas heat. Humidity is increased during the early phases of cooking since heat transfer is more efficient at high humidity. In the examples, the first minute of cooking is to set the product in its final shape and have it ready for the liquid smoke dip. The internal temperature for hot dogs during cooking is about 155 to 160° F. In these examples, the following cooking conditions of smokehouse processing were used with RH used to indicate relative humidity and RT indicating room temperature:

| | | Dry Bulb | Wet Bulb | |
|---|---|---|---|---|
| Process | Time | Temp. (° F.) | Temp. (° F.) | % RH |
| Cook-Predry | 1 min | 155 | | |
| Liquid Smoke | 10 s | RT | RT | |
| dipping | | | | |
| Cook | 5 min | 155 | 109 | 24 |
| Steam Cook | 1 min | 170 | 190 | 100 |

### Reconstitution

Reconstitution is a method of heating a fully cooked product to make it ready for the consumer. Reconstitution methods for hot dogs/sausages that can be used are microwaving, grilling, boiling and frying. The product is generally frozen or refrigerated and needs to be put back to a temperature where the product is to be eaten.

The invention is further illustrated by the following examples with all parts and percentages given by weight and all temperatures in degrees Celsius unless otherwise noted. In these examples, several different starches were initially prepared with or without modification and with or without dispersing. These starches are identified in Table A: Key To Starch Compositions and used and referred to in the following examples.

### EXAMPLE 1

Starches were combined with collagen to form composites at a ratio of 2.86 parts starch to 1 part collagen on a dry basis. The prepared composites, identified in Table 1, were co-extruded with emulsion meats using the procedure and equipment as described in the U.S. Pat. No. 6,235,328 patent previously noted. The encased food or food products prepared were hot dogs and were subjected to smokehouse processing and reconstitution as described earlier. The results are given in Table 1.

The starches were dispersed and hydrated according to the column “Dispersion Method” in Table 1 and blended with collagen to form a composite. In Composite No. 1, the starch (Starch designation I) was granular cornstarch without modification or dispersion. In Composite No. 2, the starch (Starch designation I) was a cornstarch without modification that was dispersed by cooking. In Composite No. 3, the starch (Starch designation XIV) was cornstarch without chemical modification that was physically modified to pregelatinize by extrusion and hydrated to form a colloidal dispersion. In Composite No. 4, the starch (Starch designation XIII) was chemically unmodified cornstarch that was physically modified by cook spray-drying and hydrated to form a colloidal dispersion. In all cases 10% weight solids of starch and water was used. The starch was allowed to cool to ambient temperature or placed under refrigeration prior to forming the composite. All starch/collagen composites were made using a vacuum bowl chopper to intimately mix without incorporating gas or air. The composite was then fed to the extruder along with the emulsion meats (separate casing material hopper and meat hopper) and metered using metering pumps into the co-extruder head at an appropriate setting to achieve stated ratios. A salt solution of dipotassium phosphate at a weight ratio of 50-70% in water was used and the materials co-extruded in accordance with the procedures described in the '328 patent. The resulting hot dog products were collected and dried and optionally dipped in liquid smoke before going to the smokehouse for cooking and evaluation. The products were then cooled in a cold water bath and refrigerated and frozen for later reconstitution evaluations.

After subjecting the products to co-extrusion, smokehouse processing, reconstitution and evaluating G′, as described above, it was found that composites 2 through 4 containing starch in combination with collagen have successfully been used to provide encased food products. Results are given in Table 1. This example illustrates the use of combining high levels of select starch (non-degraded, amylose containing and dispersed) with collagen to form useful casing material. A single starch base (unmodified dent corn) dispersed or hydrated to various degrees (nos. 1-4: native granular, pregelatinized {hydrated} and dispersed {cooked}) was used in the co-extrusion process. For starch to function at a high level to replace collagen, it needs to be used in a hydrated or dispersed form. Non-hydrated starch actually weaken the wet (in-process) film strength resulting in a non-continuous, non-uniform blistered film of the composite and resulted in hot dogs that did not retain their shape during the crimping/cutting process into individual links. These products were not suitable for further processing in the subsequent smoke house or reconstitution steps necessary for the application. Additionally, pregelatinization, through cook-spray-drying and extrusion was successfully demonstrated.

### EXAMPLE 2

Amylose and non-amylose starches were prepared and evaluated in a manner similar to Example 1 and the results given in Table 2.

This example illustrates the use of a chemically and physically unmodified amylose containing starch (dent cornstarch), Composite No. 1, as compared to a chemically and physically unmodified amylopectin containing starch (waxy cornstarch), Composite No. 2, both in the cooked (dispersed) state. For an unmodified dispersed starch to function to replace collagen, the starch needs to be amylose containing. Unmodified, non-amylose containing starch, such as those composed primarily of amylopectin, actually weaken the wet (in-process) film strength resulting in a non-continuous, non-uniform blistered film of the composite and results in hot dogs that do not retain their shape during the crimping/cutting process into individual links. This made the products unsuitable for further processing in the subsequent smoke house or reconstitution steps. To make a non-amylose containing starch to function in this application, it must be crosslinked or inhibited to gel and provide a G′ greater than 600 Pa as demonstrated with the successful performance of Composite No. 3 which used starch no. XVII, a propylene oxide modified waxy starch with additional phosphorous oxychloride treatment.

### EXAMPLE 3

Degraded and non-degraded starches were prepared and evaluated in a manner similar to Example 1. This example illustrates the use of a non-degraded starch, Composite No. 1, as compared to a degraded starch (acid converted AC), Composite No. 2, both derived from the same starch-base (dent cornstarch) and both in the cooked (dispersed) state. Results are given below in Table 3.

For starch to replace collagen, the starch needs to be non-degraded and have a molecular weight that is similar to the native (unmodified) starch-base from which it is derived. Degraded starch, as used in Composite No. 2, actually weakened the wet (in-process) film strength and resulted in a non-continuous, non-uniform, blistered film of the composite and further resulted in hot dogs that did not retain their shape during the crimping/cutting process into individual links. The hot dogs were found unsuitable for further processing in the subsequent smokehouse or reconstitution steps. Therefore, degraded starch bases, such as those having molecular weight reduced by a hydrolytic process (e.g., acid conversion) are not suitable for the co-extrusion process to form encased food products.

### EXAMPLE 4

Several chemically modified starches were prepared and evaluated in a manner similar to Example 1. Results are given in Table 4.

This example illustrates the use of food acceptable chemical modification of starch that [yield] yields starch esters and starch ethers through monosubstitution and/or cross-linking of the starch. The results show that when monosubstitution and/or cross-linking treatment is dominant or too strong, depending upon the starch-base, the composite fails (see Composites Nos. 1-3). Failure is evidenced by inadequate wet (in-process) film strength, which resulted in a non-continuous, non-uniform, blistered film of the composite and further resulted in hot dogs that did not retain their shape as required for further processing in the subsequent smoke house or reconstitution steps. A high level of monosubstitution has a negative effect on the film properties of the composite, dependent upon the base-starch used and, if present, the level of cross-linking. Higher amylose containing starch can withstand higher treatment levels of such reagents and still perform in the application. Additionally, the higher the crosslinking, the more difficult it is to cook/hydrate the starch, hence, a negative application response is observed. This is also dependent upon the base starch used and, if present, the level of monosubstitution.

### EXAMPLE 5

This example illustrates food acceptable physical treatments of starch. Starch samples were prepared in a manner similar to Example 1 and subject to various pregelatinization methods with results given in Table 5. This illustrates the advantage of not having to disperse the starch by cooking for manufacturing convenience. Additionally, a starch that has been physically processed to thermally inhibit (non-chemical modification) has been cooked to disperse and provides acceptable application results (Composite No. 3).

### EXAMPLE 6

Several starches were prepared and evaluated in a manner similar to Example 1. Results are given in Table 6.

The results illustrate that G′ (Pa), a measure of the gelling properties of the starch, relates to the performance of the starch in the co-extrusion process. The composites were those having high levels of starch, with collagen at a ratio of 2.86 parts starch to 1 part collagen on a dry weight basis. Starch having a G′ less than about 600 Pa did not possess sufficient gel properties to have utility in the co-extrusion process while starch having a G′ between about 600 and 1500 Pa are most preferred. Two composites in Table 6 fell slightly out of trend (Composites 3 and 8). This can be explained by the different degree of dispersion provided by cooking condition variations between field application trials and the analytical G′ measurement conducted under ideal laboratory conditions.

### EXAMPLE 7

Several different starches that were prepared by modification and dispersing are identified in Table A. These starches were combined with collagen to form composites at a ratio of 0.71 parts of starch to 1 part collagen on a dry weight basis. The prepared composites, identified in Table 7, were co-extruded using the procedure and equipment as described in Example 1. The composites were also subjected to smokehouse processing and reconstitution and evaluated. Results are given in Table 7.

The results show that Composites 1 through 10 having a relatively low level of starch replacement (0.71 parts starch to 1 part collagen) were successfully used as casing materials. These starch-containing composites did not compromise film thickness, the dehydration step or the wet film strength during co-extrusion or handling in the smokehouse process or performance during reconstitution of the resulting hot dogs as compared to the 100% collagen control.

### EXAMPLE 8

Starch X, (POCl3 modified cornstarch), was used to prepare and evaluate composites used in forming encased food products in a manner similar to Example I. In this example, the composites were used in the extrusion process with and without the crosslinker (liquid smoke) for collagen. The results are given in Table 8 and show that the use of starch/collagen Composite No. 1 with POCl3 modified, dispersed corn starch but without the collagen crosslinker exhibited good extrudability and good film properties. The results were comparable to the product prepared using Composite 2, which had the same starch and also used a collagen crosslinker in the process. Comparison of these results shows the unnecessary use of the collagen crosslinker to get a strong casing. Two collagen controls were run to show the formation of food casings using collagen as the casing material, one using a collagen crosslinker and one without the collagen crosslinker. The collagen control without the crosslinker showed unfavorable results during the smoke house and reconstitution steps. These results show the unexpected film forming properties when using the selected starch in combination with collagen where the collagen does not have the dominating functionality anymore and therefore the crosslinker is not needed.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

TABLE A
KEY TO STARCH COMPOSITIONS

| Starch | | Modification | | | |
|---|---|---|---|---|---|
| Designation | Base | Chemical | Physical | Physical Form | Abbreviated Designation¹ |
| I | dent corn | Unmodified | unmodified | granular | Corn Starch |
| II | waxy corn | Unmodified | unmodified | granular | Waxy Corn Starch |
| III | dent corn | 0.7% hydrochloric acid treatment | unmodified | granular | AC Corn Starch |
| IV | dent corn | 7% acetic anhydride treatment | unmodified | granular | Ac₂O Corn Starch |
| V | dent corn | 3% octenyl succinic anhydride | unmodified | granular | OSA Corn Starch |
| | | treatment | | | |
| VI | dent corn | 0.39% bound phosphate by sodium | unmodified | granular | PO₄ Corn Starch |
| | | tripolyphosphate treatment | | | |
| VII | dent corn | 4.8% propylene oxide treatment | unmodified | granular | PO Corn Starch |
| VIII | high amylose corn | 15% propylene oxide treatment | unmodified | granular | PO High Amylose Corn Starch |
| IX | high amylose corn | 0.34% bound phosphate by sodium | unmodified | granular | PO₄ High Amylose Corn Starch |
| | | tripolyphosphate treatment | | | |
| X | dent corn | 0.085% phosphorous oxychloride | unmodified | granular | POCl₃ Corn Starch |
| | | treatment | | | |
| XI | potato | Unmodified | thermally | granular | TI Potato Starch |
| | | | inhibited | | |
| XII | dent corn | 7.6% propylene oxide/0.008% | unmodified | granular | PO/POCl₃ Corn Starch |
| | | phosphorous oxychloride treatment | | | |
| XIII | dent corn | Unmodified | pregelatinized | agglomerated | SD Corn Starch |
| | | | (spray-dried) | particle | |
| XIV | dent corn | Unmodified | pregelatinized | fractionated | EXT Corn Starch |
| | | | (extruded) | particle | |
| XV | high amylose corn | Unmodified | pregelatinized | particle | SD High Amylose Corn Starch |
| | | | (spray-dried) | | |
| XVI | high amylose corn | 0.34% bound phosphate by sodium | pregelatinized | particle | SD/PO₄ High Amylose Corn |
| | | tripolyphosphate treatment | (spray-dried) | | Starch |
| XVII | waxy corn | 7.1% propylene oxide/0.034% | unmodified | granular | PO/POCl₃ Waxy Corn Starch |
| | | phosphorous oxychloride treatment | | | |

¹AC: Acid Converted
¹TI: Thermally Inhibited
¹SD: Spray Dried
¹EXT: Extruded

TABLE 1
STARCH/COLLAGEN (2.86:1) COMPOSITES USING VARIOUS PHYSICAL FORMS OF STARCH

| | | | | Application Results | | | |
|---|---|---|---|---|---|---|---|
| | Starch | | | Co-Extrusion | Smoke House | | |
| No. | Designation | Abbreviated Designation | Dispersion Method | Processing | Processing | Reconstitution | G′ (Pa) |
| 1 | I | Corn Starch | none- granular | failure | — | — | — |
| 2 | I | Corn Starch | cook-dispersed | acceptable | acceptable | acceptable | 1433 |
| 3 | XIV | EXT Corn Starch | hydrate-pregel | acceptable | acceptable | acceptable | 1236 |
| | | | (extrusion) | | | | |
| 4 | XIII | SD Corn Starch | hydrate-pregel | acceptable | acceptable | acceptable | 604 |
| | | | (cook-spray-dry) | | | | |
| — | collagen | Collagen Control | — | acceptable | acceptable | acceptable | — |

TABLE 2
STARCH/COLLAGEN (2.86:1) COMPOSITES USING AMYLOSE vs. NON-AMYLOSE CONTAINING STARCH

| | | | | Application Results | | | |
|---|---|---|---|---|---|---|---|
| | Starch | | Dispersion | Co-Extrusion | Smoke House | | |
| No. | Designation | Abbreviated Designation | Method | Processing | Processing | Reconstitution | G′ (Pa) |
| 1 | I | Corn Starch | cook-dispersed | acceptable | acceptable | acceptable | 1433 |
| 2 | II | Waxy Corn Starch | cook-dispersed | failure | — | — | 14 |
| 3 | XVII | PO/POCl₃ Waxy Corn Starch | cook-dispersed | acceptable | acceptable | acceptable | 1667 |
| — | Collagen | Collagen Control | — | acceptable | acceptable | acceptable | — |

TABLE 3
STARCH/COLLAGEN (2.86:1) COMPOSITES USING DEGRADED vs.
NON DEGRADED CONTAINING STARCH

| | | | | Application Results | | | |
|---|---|---|---|---|---|---|---|
| | Starch | Abbreviated | Dispersion | Co-Extrusion | Smoke House | | |
| No. | Designation | Designation | Method | Processing | Processing | Reconstitution | G′ (Pa) |
| 1 | I | Corn Starch | cook-dispersed | Acceptable | acceptable | acceptable | 1433 |
| 2 | III | AC Corn Starch | cook-dispersed | Failure | — | — | 105 |
| — | collagen | Collagen Control | — | Acceptable | acceptable | acceptable | — |

TABLE 4
STARCH/COLLAGEN (2.86:1) COMPOSITES CONTAINING CHEMICALLY MODIFIED STARCH

| | | | | Application Results | | | |
|---|---|---|---|---|---|---|---|
| | Starch | | | Co-Extrusion | Smoke House | | |
| No. | Designation | Abbreviated Designation | Dispersion Method | Processing | Processing | Reconstitution | G′ (Pa) |
| 1 | IV | AC₂0 Corn Starch | cook-dispersed | failure | — | — | 301 |
| 2 | VII | PO Corn Starch | cook-dispersed | failure | — | — | — |
| 3 | XII | PO/POCl₃ Corn Starch | cook-dispersed | failure | — | — | — |
| 4 | VI | PO₄ Corn Starch | cook-dispersed | just acceptable | acceptable | acceptable | 1329 |
| | | | | (borderline) | | | |
| 5 | IX | PO₄ High Amylose Corn Starch | cook-dispersed | just acceptable | acceptable | acceptable | 165 |
| | | | | (borderline) | | | |
| 6 | XVI | SD/PO₄ High Amylose Corn Starch | Hydrated-dispersed | just acceptable | acceptable | acceptable | — |
| | | | | (borderline) | | | |
| 7 | X | POCl₃ Corn Starch | cook-dispersed | acceptable | acceptable | acceptable | 1366 |
| 8 | VIII | PO High Amylose Corn Starch | cook-dispersed | acceptable | acceptable | acceptable | — |
| 9 | V | OSA Corn Starch | cook-dispersed | acceptable | acceptable | acceptable | — |
| — | Collagen | Collagen Control | — | acceptable | acceptable | acceptable | — |

TABLE 5
STARCH/COLLAGEN COMPOSITES (2.86:1) CONTAINING PHYSICALLY MODIFIED STARCH

| | | | | Application Results | | | |
|---|---|---|---|---|---|---|---|
| | Starch | | | Co-Extrusion | Smoke House | | |
| No. | Designation | Abbreviated Designation | Dispersion Method | Processing | Processing | Reconstitution | G′ (Pa) |
| 1 | XV | SD High Amylose Corn Starch | Hydrated-dispersed | acceptable | acceptable | acceptable | — |
| 2 | XIII | SD Corn Starch | Hydrated-dispersed | acceptable | acceptable | acceptable | 604 |
| 3 | XI | TI Potato Starch | cook-dispersed | acceptable | acceptable | acceptable | 1200 |
| 4 | XIV | EXT Corn Starch | Hydrated-dispersed | acceptable | acceptable | acceptable | 1236 |
| — | Collagen | Collagen Control | — | acceptable | acceptable | acceptable | — |

TABLE 6
CORRELATION OF STARCH/COLLAGEN (2.86:1) COMPOSITES TO G′

| | | | | Application Results | | | |
|---|---|---|---|---|---|---|---|
| | Starch | | | Co-Extrusion | Smoke House | | |
| No. | Designation | Abbreviated Designation | Dispersion Method | Processing | Processing | Reconstitution | G′ (Pa) |
| 1 | II | Waxy Corn Starch | cook-dispersed | failure | — | — | 14 |
| 2 | III | AC Corn Starch | cook-dispersed | failure | — | — | 105 |
| 3 | IX | PO₄ High Amylose Corn Starch | cook-dispersed | just acceptable | acceptable | acceptable | 165 |
| | | | | (borderline) | | | |
| 4 | IV | Ac₂O Corn Starch | cook-dispersed | failure | — | — | 301 |
| 5 | XIII | SD Corn Starch | Hydrated-dispersed | acceptable | acceptable | acceptable | 604 |
| 6 | XI | TI Potato Starch | cook-dispersed | acceptable | acceptable | acceptable | 1200 |
| 7 | XIV | EXT Corn Starch | Hydrated-dispersed | acceptable | acceptable | acceptable | 1236 |
| 8 | VI | PO₄ Corn Starch | cook-dispersed | just acceptable | acceptable | acceptable | 1329 |
| | | | | (borderline) | | | |
| 9 | X | POCl₃ Corn Starch | cook-dispersed | acceptable | acceptable | acceptable | 1366 |
| 10 | I | Corn Starch | cook-dispersed | acceptable | acceptable | acceptable | 1433 |
| 11 | XVII | PO/POCL₃ WaxyCorn Starch | cook-dispersed | acceptable | acceptable | acceptable | 1667 |

TABLE 7
STARCH/COLLAGEN (0.71:1) COMPOSITES CONTAINING LOW LEVELS OF STARCH

| | | | | Application Results | | |
|---|---|---|---|---|---|---|
| | | | | | Smoke | |
| | Starch | | | Co-Extrusion | House | |
| No. | Designation | Abbreviated Designation | Dispersion Method | Processing | Processing | Reconstitution |
| 1 | I | Corn Starch | None- granular | just acceptable | acceptable | acceptable |
| | | | | (borderline) | | |
| 2 | I | Corn Starch | Cook-dispersed | Acceptable | acceptable | acceptable |
| 3 | II | Waxy Corn Starch | Cook-dispersed | Acceptable | acceptable | acceptable |
| 4 | VI | PO₄ Corn Starch | Cook-dispersed | Acceptable | acceptable | acceptable |
| 5 | VIII | PO High Amylose Corn Starch | Cook-dispersed | Acceptable | acceptable | acceptable |
| 6 | IX | PO₄ High Amylose Corn Starch | Cook-dispersed | Acceptable | acceptable | acceptable |
| 7 | X | POCl₃ Corn Starch | Cook-dispersed | Acceptable | acceptable | acceptable |
| 8 | XII | PO/POCl₃ Corn Starch | Cook-dispersed | Acceptable | acceptable | acceptable |
| 9 | XIII | SD Corn Starch | Hydrated-dispersed | Acceptable | acceptable | acceptable |
| 10 | XVI | SD/PO₄ High Amylose Corn Starch | Hydrated-dispersed | Acceptable | acceptable | acceptable |
| — | collagen | Collagen Control | — | Acceptable | acceptable | acceptable |

TABLE 8
STARCH/COLLAGEN COMPOSITES (2.86:1), effect of collagen CROSS LINKER (Liquid Smoke)

| | | | | | Application Results | | | |
|---|---|---|---|---|---|---|---|---|
| | Starch | Abbreviated | Collagen Cross | Dispersion | Co-Extrusion | Smoke House | | G′ |
| No. | Designation | Designation | Linker (liquid smoke) | Method | Processing | Processing | Reconstitution | (Pa) |
| 1 | X | POCl₃ Corn Starch | NO | cook-dispersed | acceptable | acceptable | acceptable | 1366 |
| 2 | X | POCl₃ Corn Starch | YES | cook-dispersed | acceptable | acceptable | acceptable | 1366 |
| — | collagen | Collagen Control | NO | — | acceptable | failure | failure | — |
| — | Collagen | Collagen Control | YES | — | Acceptable | acceptable | Acceptable | — |

What is claimed is:

1. A casing material for food products comprising: collagen and
a) a gel forming, non-degraded, amylose containing dispersed starch, or
b) a gel forming, non-degraded, chemically crosslinked or physically inhibited amylopectin dispersed starch,
wherein the starch is characterized by a G′ of 600 Pa or greater at a frequency of 0.1 rad/sec at 25° C. provided the starch was prepared at a solid concentration of 10 wt. %, the amount of starch to collagen being from about 0.05:1 to 10:1 parts by weight, based on the dry weight of starch and collagen.

2. The casing material of claim 1 wherein the starch has a G′ of from about 600 to 500,000 Pa.

3. The casing material of claim 2 wherein the starch is an amylose containing starch having an amylose content of from about 10 to 98 wt. %.

4. The casing material of claim 3 wherein the amylose containing starch is selected from the group consisting of corn, potato, wheat, sago, tapioca, sorghum, rice, pea and high amylose starch.

5. The casing material of claim 2 wherein the starch is a chemically crosslinked or physically inhibited amylopectin dispersed starch and has an amylopectin content of about 90% or more by weight.

6. The casing material of claim 5 wherein the chemically crosslinked or physically inhibited amylopectin starch is selected from the group consisting of waxy maize, waxy rice, waxy sorghum, waxy potato and waxy tapioca.

7. The casing material of claim 6 wherein the starch is chemically crosslinked with a crosslinking agent selected from the group consisting of phosphorous oxychloride, epichlorohydrin, sodium trimetaphosphate and adipic-acetic anhydride.

8. The casing material of claim 2 wherein the amount of starch to collagen used is from about 0.05:1 to 4:1.

9. An encased food product wherein casing material forms an outer layer for the food and comprises:
collagen, and
a) a gel forming, non-degraded, amylose containing dispersed starch, or
b) a gel forming, non-degraded, chemically crosslinked or physically inhibited amylopectin dispersed starch,
wherein the starch is characterized by a G′ of 600 Pa or greater at a frequency of 0.1 rad/sec at 25° C. provided the starch was prepared at a solid concentration of 10 wt. %, the amount of starch to collagen being from about 0.05:1 to 10:1 parts by weight, based on the dry weight of starch and collagen.

10. The encased food product of claim 9 wherein the starch has a G′ of from about 600 to 500,000 Pa.

11. The encased food product of claim 10 wherein the starch is an amylose containing starch having an amylose content of from about 10 to 98% by weight.

12. The encased food product of claim 11 wherein the amylose containing starch is selected from the group consisting of corn, potato, wheat, sago, tapioca, sorghum, rice, pea and high amylose starch.

13. The encased food product of claim 10 wherein the starch is a chemically crosslinked or physically inhibited amylopectin starch having an amylopectin content of 90% or more by weight.

14. The encased food product of claim 13 wherein the chemically crosslinked or physically inhibited amylopectin starch is selected from the group consisting of waxy maize, waxy rice, waxy sorghum, waxy potato, and waxy tapioca.

15. The encased food product of claim 14 wherein the amylopectin starch is crosslinked with a crosslinking agent selected from the group consisting of phosphorous oxychloride, epichlorohyrin, sodium trimetaphosphate and adipic-acetic anhydride.

16. The encased food product of claim 14 wherein the amylopectin starch is physically inhibited by thermal inhibition.

17. The encased food product of claim 10 wherein the food is meat, meat analog, vegetable, cheese or blend thereof.

18. The encased food product of claim 10 wherein the amount of starch to collagen is from about 0.05:1 to 4:1 parts by weight, based on the dry weight of starch and collagen.

19. The encased food product of claim 10 wherein the product is formed by co-extruding the collagen and starch with the food and then dehydrated by passing through an alkaline salt bath.

20. A casing material for food products comprising collagen and starch, the amount of starch to collagen being from about 0.05:1 to 0.8:1 parts by weight based on the dry weight of starch and collagen.

21. The casing material of claim 20 wherein the starch is selected from the group consisting of corn, potato, wheat sago, tapioca, sorghum, rice, pea, and the waxy and high amylose varieties of these starches.

22. An encased food product wherein casing material forms an outer layer for the food product and comprises collagen and starch, the amount of starch to collagen being from about 0.05:1 to 0.8:1 parts by weight based on the dry weight of starch and collagen.

23. The encased food product of claim 22 wherein the starch is selected from the group consisting of corn, potato, wheat, sago, tapioca, sorghum, rice, pea, and the waxy and high amylose varieties of these starches.

24. The encased food product of claim 23 wherein the collagen and starch is co-extruded with the food and then dehydrated by passing through an alaline salt bath.
